(19) United States
(12) Patent Application Publication
(10) Pub. No.: US 2014/0130408 A1
(43) Pub. Date: May 15, 2014

(54) COIR FIBER AND COIR PITH SEED MAT

(71) Applicant: X-Seed Inc., Clear Lake, MN (US)

(72) Inventors: Charles R. Fagin, Clear, MN (US); Kevin Rogers, Tangent, OR (US)

(21) Appl. No.: 14/077,693

(22) Filed: Nov. 12, 2013

Related U.S. Application Data
(60) Provisional application No. 61/725,112, filed on Nov. 12, 2012.

(51) Int. Cl. A01C 1/04

(52) U.S. Cl. CPC A01C 1/044
USPC 47/56; 53/440; 53/435; 53/430

(57) ABSTRACT

A seed mat utilizing coir fiber (base or bottom) with a second layer of coir pith particles adhesive, and seeds and possible nutrients (top), the coir pith has a compression of 5:1, the coir fiber layer and adhesive holds the seed and coir pith mixture in place for significant reduction of run off and also adds moisture retention allowing for faster and more successful germination and turf establishment.

### CLAIM OF PRIORITY

This application claims priority to U.S. Provisional Patent Application No. 61/725,112 filed Nov. 12, 2012, the entire application of which, is incorporated by reference.

### FIELD OF THE INVENTION

This invention generally relates to a novel seed germination and growth medium and a method for increasing ease in seed planting, germination and growth.

### BACKGROUND OF THE INVENTION

A beautiful lawn and garden can offer significant value to a home or business. However, as people's schedules become more and more busy, the time necessary to devote to cultivating a garden diminishes, and many people try to find an easier way to obtain the benefits of a beautiful lawn or garden without all the work. In addition, as people live more closely together space decreases and people have less room to garden.

To plant a lawn or garden, many tools and a large time commitment have typically been required. The ground must be prepared or tilled to receive the seeds. If the soil is not of good quality, topsoil must be laid and prepared for the seeds. The seeds then need to be spaced depending on which type of plant the seeds will produce. Fertilizer must be added and the seeds need to be covered with soil. Mulch is then added over the planted seeds to prevent erosion and preserve moisture. The ground must then be kept very moist for the seeds to germinate. During an especially hot season the ground can easily dry and must be watered several times a day.

Once the seeds germinate and sprouts appear they often need to be thinned to allow maximum growth. In addition, frequent weeding is necessary or the unwanted weeds can choke out the flower and/or vegetable plants. Weeding can take large amounts of time and requires bending and kneeling, which can be difficult for many people to do for an extended period. Furthermore, some plants can be difficult to grow and require even more maintenance and upkeep than is typically required.

Various gardening and germination aids are available, but many require underlying soil that must be prepared and most need to be covered with and/or surrounded by topsoil for germination and growth to occur. In addition, such aids are lightweight and can easily be blown away. The sheets dissolve eventually after watering and supply no actual anchoring or strength to the plants. They are therefore not suitable for continued growth of plants past germination. In addition, they can reportedly only be used in the soil outdoors. The present invention can be used inside or outside on any surface or in any container.

Because so many people would like a beautiful lawn or garden that is also easy to prepare, grow and maintain, it is an object of the invention to provide a kit and method of planting that supplies an easy solution to the many difficulties involved in preparing and maintaining a lawn or garden, and in assembling the necessary components. The present invention can be optimized and/or selected to be used both indoors and outdoors, and can be placed on any type of surface or in a container. Of course, the breadth and scope of the invention as defined by the claims should not be limited by reference to any object of the invention.

### SUMMARY OF THE INVENTION

The invention generally includes a seed mat utilizing coir fiber (base or bottom) with a second layer of coir pith particles adhesive, and seeds and possible nutrients (top). In a preferred embodiment, the coir pith compression is 5:1, allowing the growth medium to absorb and retain five times the amount of water to encompass the seed, providing needed moisture and protection. The coir fiber layer and adhesive holds the seed and coir pith mixture in place for significant reduction of run off. Coir fiber also adds moisture retention allowing for faster and more successful germination and turf establishment.

### BRIEF DESCRIPTION OF THE DRAWINGS

The invention may be more completely understood in consideration of the following detailed description of various embodiments of the invention in connection with the accompanying drawings, in which:

FIG. 1 shows a method of processing coir pith in accordance with the invention.

FIG. 2 shows a process for fabricating a coir mat in accordance with the invention.

FIG. 3 shows a cross-sectional view of a coir mat in accordance with the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENT

The invention includes a seed mat utilizing coir fiber (base or bottom) with a second layer of coir pith particles adhesive, and seeds and possible nutrients (top). Coir pith compression is 5:1, allowing the growth medium to absorb and retain five times the amount of water to encompass the seed providing needed moisture and protection. The coir fiber layer and adhesive holds the seed and coir pith mixture in place for significant reduction of run off. Coir fiber also adds moisture retention allowing for faster and more successful germination and turf establishment.

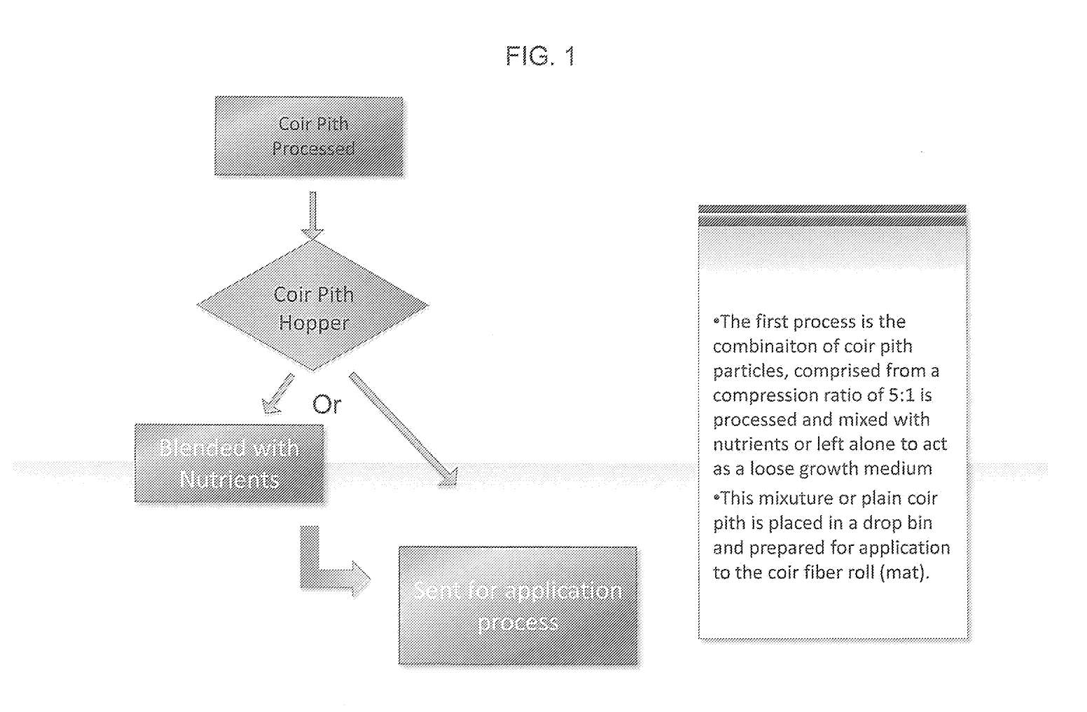

With reference to FIG. 1, coir pith is processed in a coir pith hopper. Nutrients can be blended or the coir can be sent for the application process. The first process is the combination of coir pith particles, comprised of a compression ratio of 5:1 and is processed and mixed with nutrients or left alone to act as a loose growth medium. This mixture or coir and nutrients, or the plain coir pith is then placed in a drip bind and prepared for application to the coir fiber roll (mat).

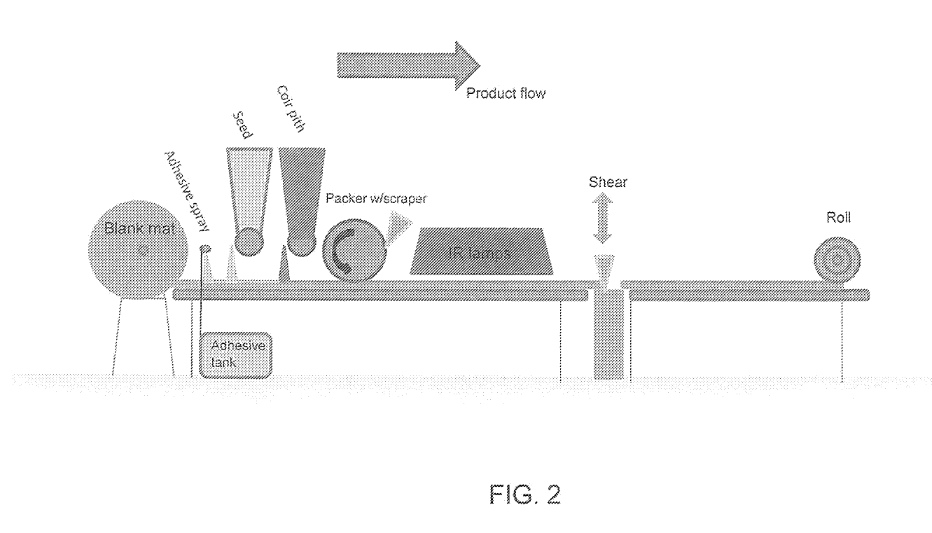

With reference to FIG. 2, the application process will now be discussed. A blank coir mat is processed by spraying the mat with adhesive. Seed is then applied to the mat and sticks to the adhesive that has been applied to the mat. Next, coir pith is applied to the mat. A packer with scraper then compresses the materials into the coir mat and the coir mat is then treated with infrared lamps. The mat is then sheared to size, and rolled for distribution and sale.

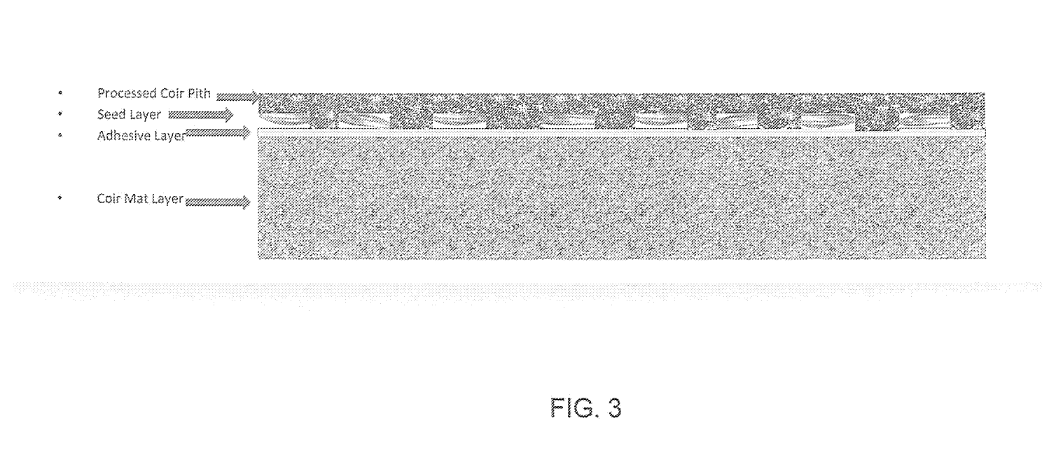

With reference to FIG. 3, the configuration of the final product will now be discussed. The bottom layer includes a coir mat layer. An adhesive layer is disposed on top of the coir mat layer. Next, a seed layer is located atop the adhesive layer, and secures the seeds to the coir mat. The processed coir pith is then disposed atop the seed layer, which can help retain moisture in the seed layer.

The present invention has the advantage of offering run-off reduction, improved germination, more rapid establishment of the seeds, enhanced water absorption and retention, and increased soil surface aeration. Ordinary straw or coir fiber mats alone only cover the seeds on top of the soil. Some conventional impregnated seed mats lack significant adhesive and contain no coir pith. Coir pith surrounds the seeds and provides a natural growth medium allowing for the seedlings to be held in place while they eventually take root in the established soil. Products that utilize coir pith alone will run off or bunch if too much water (or rain) is applied.

The present invention allows for improved germination of the seeds. For example, coir pith has proven to hold 50% more water than ordinary soils. Germinating seed is dependent upon moisture and proper nutrients. The X-Seed Roll allows for both increased water retention and run off protection which increases the amount of seeds that successfully germinate and become established.

The present invention allows for more rapid establishment of the seeds. The combination of seed, coir pith and coir fibers create more humidity that accelerates germination time. In addition, the present invention allows for increased soil surface aeration. Benefits of aeration are, loosened compacted soil, breaking-up and/or removal of thatch, improved water infiltration, improved nutrient infiltration, increased oxygen supply to roots, released carbon dioxide and the encouragement of new, deeper root growth. Additional information relative to soil surface aeration is disclosed in Matthew J. Fagerness, Aerating Your Lawn, Kansas State University, January 2001, which is hereby incorporated by reference.

Although the invention has been described with reference to preferred embodiments, workers of ordinary skill will recognize that changes can be made in form and detail without departing from the spirit and scope of the invention.

What is claimed is:

1. A seed mat comprising:
a coir fiber base;
coir pith particles adhesive disposed atop the coir fiber base, and;
seeds disposed atop the coir fiber base, wherein the seeds are affixed to the coir fiber base by the coir pith particle adhesive.

2. The seed mat of claim 1, further comprising growing nutrients disposed atop the coir fiber base.

3. The seed mat of claim 2, wherein the growing nutrients are affixed to the coir fiber base by the coir pith particle adhesive.

4. The seed mat of claim 3, wherein the coir pith compression is 5:1.

5. A seed mat comprising:
a coir mat layer;
an adhesive layer disposed on top of the coir mat layer;
a seed layer located atop the adhesive layer, whereby the adhesive layer secures the seeds to the coir mat;
processed coir pith disposed atop the seed layer, whereby the processed coir pith is configured to retain moisture in the seed layer.

6. The seed mat of claim 5, further comprising growing nutrients disposed atop the coir fiber base.

7. The seed mat of claim 6, wherein the growing nutrients are affixed to the coir fiber base by the adhesive layer.

8. The seed mat of claim 7, wherein the coir pith compression is 5:1.

9. A method of making a seed mat comprising the steps of:
providing a blank coir mat;
applying adhesive to the mat;
applying seed to the mat so the seed sticks to the adhesive that has been applied to the mat.

10. The method of claim 9, further comprising the step of applying coir pith to the mat.

11. The method of claim 10, further comprising the step of compressing the seed into the coir mat.

12. The method of claim 11, wherein a packer with a scraper is used to perform the step of compressing the materials into the coir mat.

13. The method of claim 12, further comprising the step of treating the coir mat with infared lamps.

14. The method of claim 13, further comprising the step of shearing the coir mat to size.

15. The method of claim 14, further comprising the step of rolling the coir mat for shipping.

16. The method of claim 15, further comprising the step of packaging the coir mat.
